(19) United States
(12) Patent Application Publication
(10) Pub. No.: US 2023/0059677 A1
(43) Pub. Date: Feb. 23, 2023

(54) CHARGING METHOD, CHARGING APPARATUS, AND CHARGING SYSTEM

(71) Applicant: Huawei Digital Power Technologies Co., Ltd., Shenzhen (CN)

(72) Inventors: Xi LONG, Shenzhen (CN); Quanxi LIN, Dongguan (CN); Yichang WANG, Dongguan (CN); Zhanlin REN, Dongguan (CN)

(21) Appl. No.: 17/890,018

(22) Filed: Aug. 17, 2022

(30) Foreign Application Priority Data
Aug. 17, 2021 (CN) 202110944977.9

(51) Int. Cl. B60L 53/67; H02J 7/00; B60L 53/31; B60L 53/62

(52) U.S. Cl. CPC B60L 53/67; H02J 7/0048; H02J 7/00032; H02J 7/00712; B60L 53/31; B60L 53/62

(57) ABSTRACT

A charging method, a charging apparatus, and a charging system are described. The charging method includes a first control module enabling a first link based on target charging power of a first to-be-charged apparatus and charging power of a first charging apparatus. The first to-be-charged apparatus waits for being charged on a first charging parking space. The first control module corresponds to the first charging apparatus. The first control module enables the first link and charges the first to-be-charged apparatus at a first shared charging power. The first shared charging power includes real-time charging power of at least one first charging apparatus and at least one second charging apparatus.

### CROSS-REFERENCE TO RELATED APPLICATION

This application claims priority to Chinese Patent Application No. 202110944977.9, filed on Aug. 17, 2021, which is hereby incorporated by reference in its entirety, including any references cited therein.

### TECHNICAL FIELD

This application relates to the field of charging technologies, and in particular, to a charging method, a charging apparatus, and a charging system.

### BACKGROUND

With development of new energy technologies, technologies related to electric vehicles are gradually becoming mature. As a service infrastructure matching the electric vehicle, a charging station can quickly, efficiently, economically, and safely provide electric energy required for running various electric vehicles. In a current charging station, a charging module in a charging pile corresponds to a fixed parking space or is shared by a limited quantity of parking spaces, and inflexibly responds to a charging power requirement of a nearby parking space. Therefore, a scheduling range of the charging module is limited, and a problem of insufficient utilization exists.

Therefore, how to overcome the disadvantage of insufficient utilization of the charging module and improve charging experience is a problem that urgently needs to be resolved.

### SUMMARY

This application provides a charging method, a charging apparatus, and a charging system, to expand a charging scheduling range, improve utilization of a charging apparatus, and improve charging experience.

According to a first aspect, a charging system is provided. The system may include at least two charging apparatuses, at least one first charging apparatus in the at least two charging apparatuses includes at least two output ports, a first output port in the at least two output ports is connected to a first charging parking space corresponding to the first charging apparatus, a first link exists between a second output port in the at least two output ports and a third port of at least one second charging apparatus in the at least two charging apparatuses, the third port is connected to a fourth port of the second charging apparatus, and the fourth port is connected to a second charging parking space corresponding to the second charging apparatus.

A first control module configured in the first charging apparatus is configured to enable the first link based on target charging power of a first to-be-charged apparatus and charging power of the first charging apparatus. The first to-be-charged apparatus waits for being charged on the first charging parking space.

The first control module enables the first link, and charges the first to-be-charged apparatus at first shared charging power. The first shared charging power includes real-time charging power of the at least one first charging apparatus and the at least one second charging apparatus.

In the charging system provided in this solution, a plurality of charging apparatuses are connected to share an electric energy reserve, so that utilization of the electric energy reserve in the charging apparatus can be improved, a charging requirement can be met in a timely manner, and charging experience can be improved.

With reference to the first aspect, in some implementations of the first aspect, the first control module is specifically configured to: when the target charging power of the first to-be-charged apparatus is greater than real-time charging power of the first charging apparatus, determine to enable the first link; or when the target charging power of the first to-be-charged apparatus is greater than a charging power threshold of the first charging apparatus, determine to enable the first link.

It should be understood that the charging power threshold may be preset, or may be determined by performance of the charging apparatus. This is not limited in this application.

With reference to the first aspect, in some implementations of the first aspect, a second control module configured in the second charging apparatus is configured to send first indication information. The first indication information indicates real-time charging power of the second charging module.

The first control module is further configured to receive the first indication information.

It should be understood that the control module may be configured in each charging apparatus, and a plurality of control modules communicate with each other in real time to learn of a real-time charging status of another charging apparatus, where the real-time charging status may include real-time charging power, to determine shared charging power. It should be further understood that a main control module may be alternatively configured in a charging station to schedule connections of a plurality of charging apparatuses. This is not limited in this application.

With reference to the first aspect, in some implementations of the first aspect, the second control module is configured to select a first sub-link based on the real-time charging power of the second charging apparatus. The first sub-link includes a connection between a second charging module and the third port, and the second charging module includes a charging module configured in the second charging apparatus.

In other words, the charging apparatus may select an internal connection based on a charging status of the charging apparatus, to meet both a charging requirement of the charging apparatus and a shared charging requirement.

With reference to the first aspect, in some implementations of the first aspect, the first control module is specifically configured to control a switch module configured in the first charging apparatus to enable or disable a connection, and the second control module is specifically configured to control a switch module configured in the second charging apparatus to enable or disable a connection.

In other words, a manner of controlling the connection by the control module may be controlling a switch on a link to be closed or opened, to enable or disable the link.

With reference to the first aspect, in some implementations of the first aspect, the plurality of charging apparatuses are connected in a first connection manner, and the first connection manner includes one of a chain-shaped connection, a star-shaped connection, a trunk-shaped connection, and a dual-ring-shaped connection.

It should be understood that a plurality of connection manners between charging apparatuses may be flexibly selected to meet different charging requirements and implement flexible electric energy sharing.

According to a second aspect, a charging apparatus is provided. The charging apparatus is the first charging apparatus or the second charging apparatus in any one of the possible implementations of the first aspect.

According to a third aspect, a charging method is provided. The method is performed by a charging system including at least two charging apparatuses, at least one first charging apparatus in the at least two charging apparatuses includes at least two output ports, a first output port in the at least two output ports is connected to a first charging parking space corresponding to the first charging apparatus, a first link exists between a second output port in the at least two output ports and a third port of at least one second charging apparatus in the at least two charging apparatuses, the third port is connected to a fourth port of the second charging apparatus, the fourth port is connected to a second charging parking space corresponding to the second charging apparatus, and the method may include the following steps.

A first control module determines, based on target charging power of a first to-be-charged apparatus and charging power of the first charging apparatus, to enable the first link. The first to-be-charged apparatus waits for being charged on the first charging parking space, and the first control module corresponds to the first charging apparatus.

The first control module enables the first link, and charges the first to-be-charged apparatus at first shared charging power. The first shared charging power includes real-time charging power of the at least one first charging apparatus and the at least one second charging apparatus.

With reference to the third aspect, in some implementations of the third aspect, when the target charging power of the first to-be-charged apparatus is greater than real-time charging power of the first charging apparatus, it is determined to enable the first link; or when the target charging power of the first to-be-charged apparatus is greater than a charging power threshold of the first charging apparatus, it is determined to enable the first link.

With reference to the third aspect, in some implementations of the third aspect, a second control module sends first indication information. The first indication information indicates real-time charging power of the second charging apparatus, and the second control module corresponds to the second charging apparatus. The first control module receives the first indication information.

With reference to the third aspect, in some implementations of the third aspect, the second control module selects a second sub-link based on the real-time charging power of the second charging apparatus. The first sub-link includes a connection between a second charging module and the third port, and the second charging module includes a charging module configured in the second charging apparatus.

With reference to the third aspect, in some implementations of the third aspect, the first control module controls a switch module configured in the first charging apparatus to enable or disable a connection, and the second control module controls a switch module configured in the second charging apparatus to enable or disable a connection.

It should be understood that explanations, supplements, and beneficial effects of the first aspect are also applicable to the second aspect and the third aspect, and details are not described herein again.

According to a fourth aspect, a control apparatus is provided. The apparatus is applied to the charging system in any one of the first aspect and the possible implementations of the first aspect, the apparatus includes a processing unit, and the processing unit is configured to enable a first link based on target charging power of a first to-be-charged apparatus and charging power of a first charging apparatus.

With reference to the fourth aspect, in some implementations of the fourth aspect, the processing unit is configured to: enable the first link, and charge the first to-be-charged apparatus at first shared charging power. The first shared charging power includes real-time charging power of at least one first charging apparatus and at least one second charging apparatus.

With reference to the fourth aspect, in some implementations of the fourth aspect, the processing unit is specifically configured to: when the target charging power of the first to-be-charged apparatus is greater than real-time charging power of the first charging apparatus, determine to enable the first link; or when the target charging power of the first to-be-charged apparatus is greater than a charging power threshold of the first charging apparatus, determine to enable the first link.

With reference to the fourth aspect, in some implementations of the fourth aspect, the control apparatus further includes a transceiver unit, a transceiver unit configured in a control apparatus of the second charging apparatus is configured to send first indication information, where the first indication information indicates real-time charging power of the second charging module, and a transceiver unit configured in a control apparatus of the first charging apparatus is configured to receive the first indication information.

With reference to the fourth aspect, in some implementations of the fourth aspect, the processing unit is further configured to select a first sub-link based on the real-time charging power of the second charging apparatus. The first sub-link includes a connection between a second charging module and a third port, and the second charging module includes a charging module configured in the second charging apparatus.

With reference to the fourth aspect, in some implementations of the fourth aspect, the processing unit is specifically configured to control a switch module configured in the first charging apparatus to enable or disable a connection.

According to a fifth aspect, a control apparatus is provided. The control apparatus includes a processor and a memory. The processor runs instructions in the memory, so that the control apparatus performs the method in any one of the third aspect and the possible implementations of the third aspect.

According to a sixth aspect, a computer-readable storage medium is provided. The computer-readable storage medium includes instructions, and the instructions are used to implement the method in any one of the third aspect and the possible implementations of the third aspect.

According to a seventh aspect, a computing device is provided. The computing device includes at least one processor and a memory. The at least one processor is coupled to the memory, and is configured to read and execute instructions in the memory, to perform the control method in any one of the ninth aspect and the possible implementations of the ninth aspect.

According to an eighth aspect, a computer program product including instructions is provided. When the instructions run on a computer, the computer performs the method in any one of the third aspect and the possible implementations of the third aspect.

According to a ninth aspect, a chip is provided. The chip includes a processor and a data interface, and the processor reads, by using the data interface, instructions stored in a memory, to perform the control method in any one of the third aspect and the possible implementations of the third aspect.

Optionally, in an implementation, the chip may further include the memory, the memory stores the instructions, the processor is configured to execute the instructions stored in the memory, and when the instructions are executed, the processor is configured to perform the method in any one of the third aspect and the possible implementations of the third aspect.

According to a tenth aspect, a chip system is provided. The chip system includes at least one processor, configured to support implementation of functions in the third aspect or some implementations of the third aspect.

In a possible design, the chip system further includes a memory, the memory is configured to store program instructions and data, and the memory is located inside or outside the processor. The chip system may include a chip, or may include a chip and another discrete component.

### BRIEF DESCRIPTION OF DRAWINGS

FIG. 1 is a schematic diagram of a charging system;

FIG. 2 is a schematic diagram of another charging system;

FIG. 3 is a schematic diagram of an example charging apparatus applicable to embodiments of this application;

FIG. 4 is a schematic diagram of an example charging system applicable to embodiments of this application;

FIG. 5(a) is a schematic diagram of a connection relationship between charging apparatuses applicable to embodiments of this application;

FIG. 5(b) is a schematic diagram of a connection relationship between charging apparatuses applicable to embodiments of this application;

FIG. 5(c) is a schematic diagram of a connection relationship between charging apparatuses applicable to embodiments of this application;

FIG. 6 is a schematic flowchart of a charging method applicable to embodiments of this application;

FIG. 7 is a schematic diagram of a charging method applicable to embodiments of this application;

FIG. 8 is a schematic block diagram of a control apparatus applicable to embodiments of this application; and

FIG. 9 is a schematic block diagram of a control apparatus applicable to embodiments of this application.

### DESCRIPTION OF EMBODIMENTS

The following describes technical solutions of this application with reference to accompanying drawings.

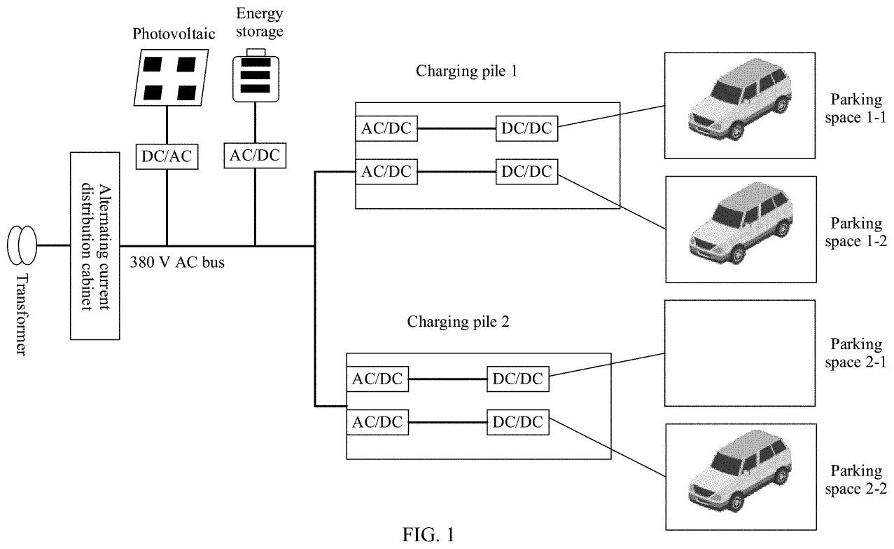

FIG. 1 is a schematic diagram of a conventional charging system. As shown in FIG. 1, a conventional charging system 100 includes a transformer 10, an alternating current distribution cabinet 11, an alternating current bus 12, a charging pile A (13), a charging pile B (14), and to-be-charged apparatuses 15 to 18. The to-be-charged apparatus may be an electric vehicle. A power supply and distribution system of a medium-and-large electric vehicle charging station usually starts from obtaining electric energy from a medium-voltage power grid. The transformer 10 transforms the electric energy into a low-voltage alternating current, and then the low-voltage alternating current converges into the alternating current distribution cabinet 11 for electric energy distribution. The alternating current enters an input side of the charging piles (13 and 14) in the station from the distribution cabinet. In the charging pile, a power conversion unit integrating alternating current to direct current (alternating current to direct current, AC/DC) and direct current to direct current (direct current to direct current, DC/DC) converts, for charging a battery, electric energy into a direct current required by an electric vehicle. Electric energy may be provided by photovoltaic power or an energy storage battery. Both the photovoltaic power and the energy storage battery are direct current power supplies. The electric energy needs to be converted into an alternating current by using a DC/AC converter, and then transferred to the battery of the electric vehicle through AC/DC conversion and DC/DC conversion. A charging module in the charging pile corresponds to a fixed parking space or is shared by a limited quantity of parking spaces, and inflexibly responds to a charging power requirement of a nearby parking space. For example, when parking spaces 1-1 and 1-2 require high charging power, and parking spaces 2-1 and 2-2 require low charging power, a module of a charging pile 2 cannot be used for a corresponding parking space of a charging pile 1 through cross-pile sharing, causing insufficient utilization of the charging module.

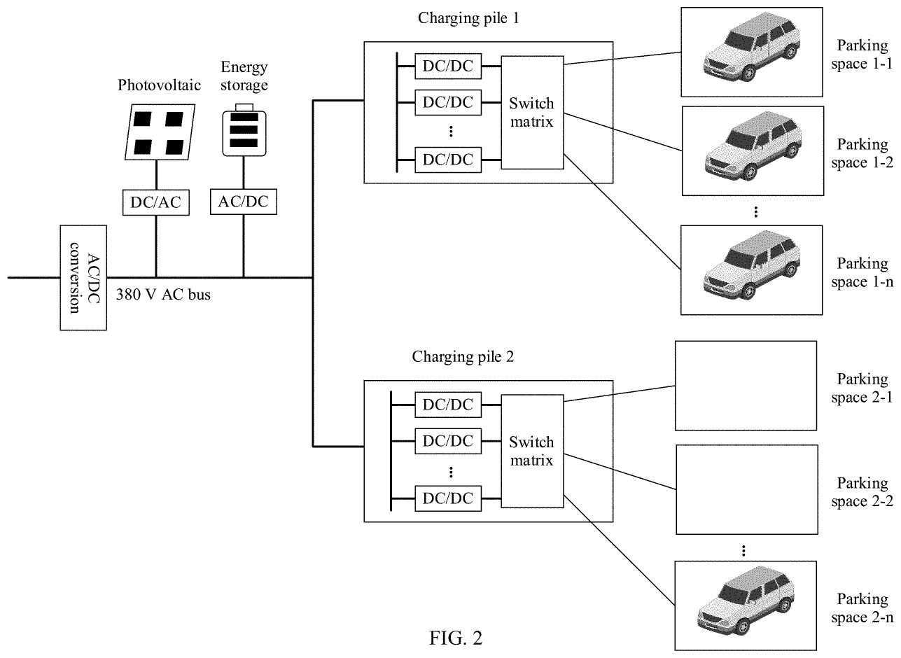

FIG. 2 is a schematic diagram of an example direct current charging apparatus. Electricity of an alternating current power grid passes through an alternating current to direct current conversion unit to form a direct current, and electric energy is distributed to an integrated pile of direct current input by using a direct current bus. DC/DC charging modules connected in parallel exist in the direct current pile, and the module can charge an electric vehicle connected to a gun head. In this system, the DC/DC module can be scheduled, within the pile by using a switch matrix, for a charged terminal connected to the charging pile, to implement an increase or a reduction in charging power of the charged terminal. However, the charging pile system with the direct current bus architecture and the switch matrix within the pile cannot schedule power of the DC/DC module from one pile to a charged terminal on another pile, and can perform scheduling only within the pile. Therefore, a scheduling range is limited. In this solution, the scheduling range of the charging module can be expanded by increasing a quantity of charged terminals in one pile. However, in this case, a volume and rated power of a single pile are quite large, and networking and expansion cannot be flexibly implemented based on a deployment status of the charging pile.

In some current charging site systems, except for mains, main power supplies and loads, for example, energy storage batteries, a photovoltaic panel, and wind power, provide electric energy in the form of a direct current, and the electric energy is converged and distributed in the form of an alternating current, causing excessive alternating current-direct current conversion. This reduces efficiency and increases costs. In addition, there are various types of vehicles in a common charging site, and charging power requirements of charging guns in different time periods are different. Due to a fixed connection between a charging module and a charging gun, low utilization is caused in a case of over-provisioning of charging modules, or charging experience is reduced in a case of under-provisioning of charging modules.

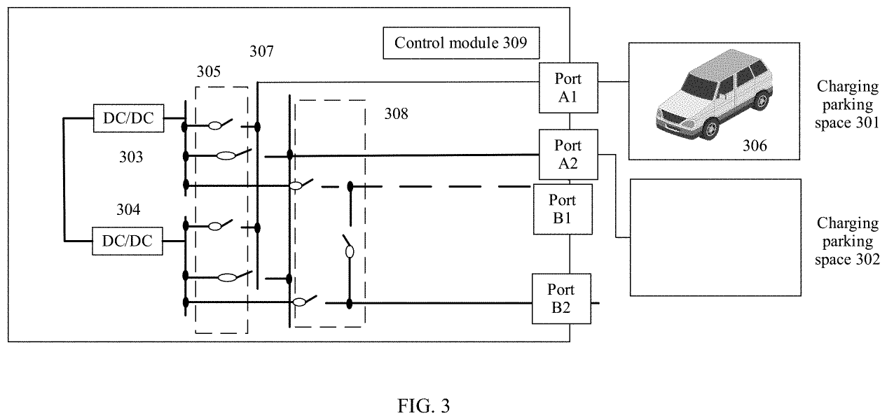

To resolve the foregoing problem, this application provides a charging apparatus. As shown in FIG. 3, the charging apparatus corresponds to fixed charging parking spaces 301 and 302, and the charging apparatus may include a plurality of charging modules 303 and 304, and may include an intra-pile sharing unit 305.

The charging module may transfer photovoltaic power or power of an energy storage battery to a to-be-charged apparatus 306, and the charging module may be a DC/DC. The charging module may be connected to the to-be-charged apparatus 306 by using a bus 307.

The intra-pile sharing unit is configured to share an electric energy reserve inside the charging apparatus. The intra-pile sharing unit may include a plurality of switches (also referred to as switch modules), and the plurality of switches correspond to the charging modules, and are configured to control connections between the corresponding charging modules and the bus to be enabled or disabled.

Optionally, the charging apparatus may further include an inter-pile sharing unit 308, configured to share an electric energy reserve between a plurality of charging apparatuses, and the intra-pile sharing unit may include a plurality of switches (also referred to as switch modules), configured to enable or disable a connection between different charging apparatuses.

The charging apparatus may further include a control module 309. The control module is configured to control the intra-pile sharing unit and/or the inter-pile sharing unit to be used or disabled. Further, the control module may be configured to control the switches in the intra-pile sharing unit and/or the switches in the inter-pile sharing unit to be opened or closed.

It should be further understood that the charging apparatus may be connected to a to-be-charged apparatus by using a port, for example, a port shown in FIG. 3. The charging apparatus may be connected to the charging parking space 301 by using a port A1, the charging apparatus may be connected to the charging parking space 302 by using a port A2, and inter-pile sharing units of different charging piles may be connected by using ports B1 and B2. The ports are merely used as examples but do not constitute a limitation, and a quantity of ports of the charging apparatus is not limited in this application.

A function of the port may also be flexibly configured. For example, the ports A1 and A2 may be alternatively configured to connect the charging apparatus to another charging apparatus, and the ports B1 and B2 may be alternatively configured to connect the charging apparatus to a charging parking space. A function or a purpose of each port is not limited in this application.

In the charging apparatus, the intra-pile sharing unit is configured, so that electric energy inside a charging apparatus can be flexibly scheduled to meet charging requirements of different to-be-charged apparatuses. In addition, the inter-pile sharing unit may be further configured, and a connection interface between different charging apparatuses may be provided, so that electric energy between different charging apparatuses can be flexibly scheduled to meet a high-power charging requirement, improve utilization of the charging apparatus, and improve charging efficiency.

The following uses an example in which the charging apparatus is a charging pile and the to-be-charged apparatus is an electric vehicle to describe the solutions of this application.

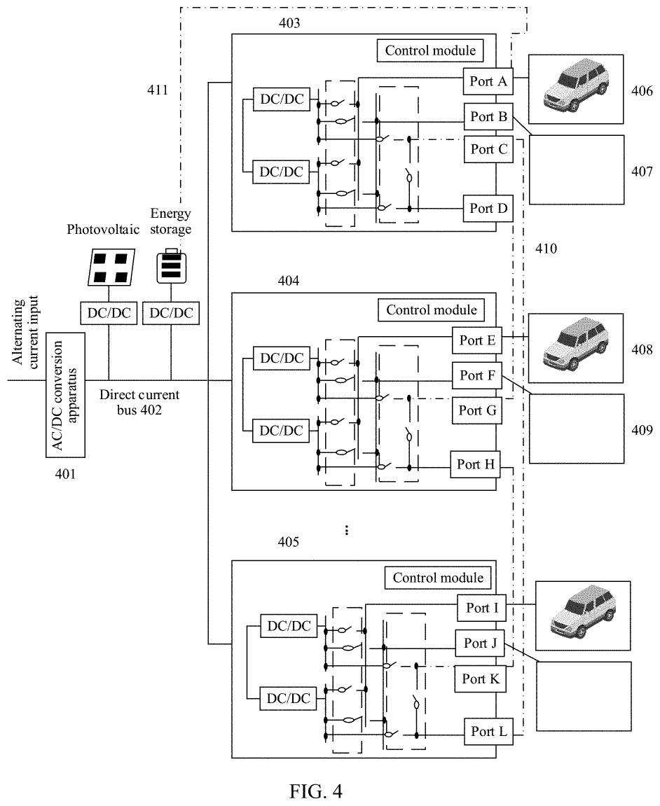

An embodiment of this application provides a charging station. As shown in FIG. 4, the charging station may include a plurality of charging piles. The charging pile is similar to the foregoing charging apparatus, and details are not described herein again.

The charging station may include a two-way AC/DC converter 401, configured to connect alternating current input and a direct current bus 402. A plurality of charging piles 403 to 405 are connected to the direct current bus 402. The charging piles are connected to to-be-charged electric vehicles 406 to 409 on charging parking spaces.

It should be understood that the alternating current input in FIG. 4 may be alternatively directly connected to a charging apparatus. In this case, an AC/DC module is configured inside the charging apparatus, and the AC/DC module may convert the alternating current input into a direct current, to charge the to-be-charged electric vehicle.

It should be understood that the charging pile and the electric vehicle may be connected by using a charging gun, and a port configured to connect to the charging gun is configured in the charging pile.

The charging station may further include a control module 406, configured to control, based on a charging requirement of the to-be-charged electric vehicle, an intra-pile sharing unit and/or an inter-pile sharing unit to be enabled or disabled, in other words, control switches to be closed or opened.

It should be understood that different charging piles may be connected. For example, the charging pile 403 and the charging pile 405 may be connected by using a direct current cable 410.

A port configured to connect to the cable is configured in the charging pile. For example, a port A in the charging pile 403 is configured to connect the charging pile to the parking space 406, a port B is configured to connect the charging pile to the parking space 407, a port C is configured to connect an inter-pile sharing unit of the charging pile 403 to an inter-pile sharing unit of the charging pile 404, and a port D is configured to connect the inter-pile sharing unit of the charging pile 403 to an inter-pile sharing unit of the charging pile 405. A port E in the charging pile 404 is configured to connect the charging pile to the parking space 408. The ports A, B, C, and D are connected by using internal connection lines, and ports E, F, G, and H are connected by using internal connection lines. Similarly, corresponding ports are also configured in the charging pile 405.

In the charging station, a photovoltaic panel, an energy storage battery, the charging pile, and the like may be connected to the direct current bus through level-1 DC/DC power conversion, to implement efficient photovoltaic-energy storage conversion and storage system to charging station conversion. In addition, the charging module of the charging pile can implement power sharing between piles to meet different charging power requirements on parking spaces.

It should be understood that the port configured in the charging apparatus may be further configured to connect to an energy storage module. For example, as shown in FIG. 4, an energy storage module in the figure may be a photovoltaic component or may be an energy storage component. The energy storage module is directly connected to the port A by using a link 411, and the port A is further connected to the charging apparatus 406. Electric energy in the energy storage module can be directly provided for the charging apparatus for use. This is not limited in this application.

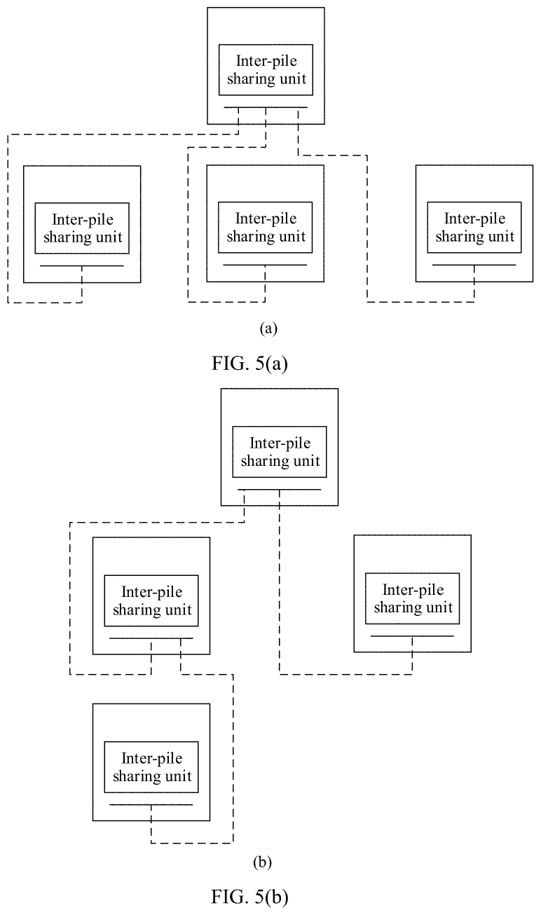

It should be understood that there may be a plurality of networking manners of sharing units of a plurality of charging piles. For example, a topology structure such as a chain shape shown in (a) in FIG. 5, a star shape shown in (b) in FIG. 5, or a dual-ring shape shown in (c) in FIG. 5 may be used. Different topology structures can provide different inter-pile sharing control policies and sharing flexibility, and the inter-pile sharing control policies and sharing flexibility may be flexibly selected based on an actual requirement.

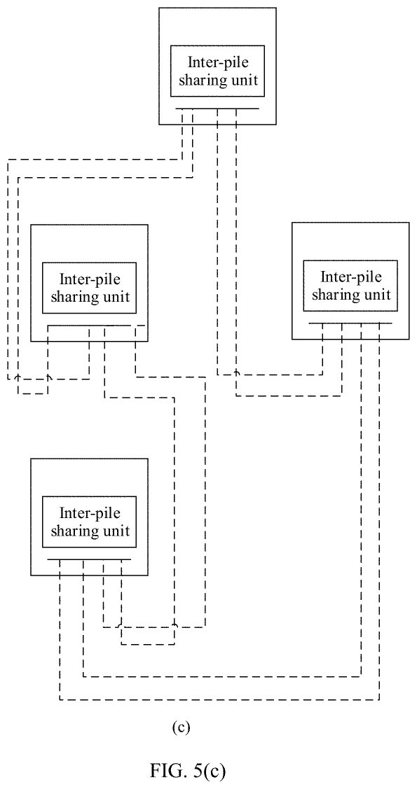

Another embodiment of this application provides a charging method, applied to the foregoing charging station, as shown in FIG. 6.

601. A control module determines, based on a charging power requirement of a to-be-charged apparatus, whether electric energy sharing is required.

602. If electric energy sharing is required, the control module controls an inter-pile sharing unit to be enabled.

603. A charging station charges the to-be-charged apparatus at shared charging power.

In the method, electric energy reserves of different charging apparatuses in the charging station are shared, so that different requirements of the to-be-charged apparatus can be met, thereby improving charging efficiency.

It should be understood that to determine, based on a requirement, whether sharing is required, the control module may perform the determining based on target charging power and real-time charging power of a charging pile, where for example, sharing is enabled when the real-time charging power of the charging pile cannot meet a charging power requirement of an electric vehicle; or may perform the determining based on target charging power and a power threshold of a charging pile, where for example, when the target charging power is greater than the threshold of the charging pile, the control module determines that sharing needs to be enabled.

It should be further understood that when determining to enable sharing, the control module further needs to determine, based on a position of the to-be-charged apparatus and a real-time charging status of each charging apparatus, to close a corresponding switch to enable a connection.

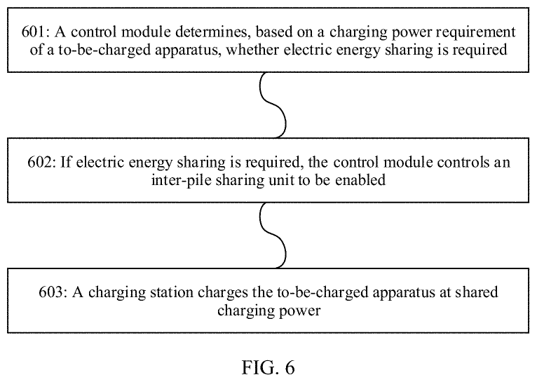

For example, as shown in FIG. 7, an electric vehicle on a charging parking space 1-1 needs to be charged.

The charging parking space is correspondingly connected to a charging pile 1. Charging power of the charging pile 1 is less than charging power required by the electric vehicle, and the control module determines that sharing needs to be enabled. Then the control module determines, based on a position of the parking space and a charging status of each charging pile, a switch that needs to be closed.

For example, if real-time charging power of the charging pile 1 and a charging pile 2 cannot meet a charging power requirement of the electric vehicle, both the charging pile 2 and a charging pile 3 need to be shared.

S3-5 and S3-6 in the charging pile 3 are closed, so that a link 3 is enabled, and electric energy of the charging pile 3 is shared with the charging pile 1.

S2-5 in the charging pile 2 and S1-5 and S1-1 in the charging pile 1 are closed, so that a link 2 is enabled, and electric energy of the charging pile 2 is shared with the charging pile 1.

S1-1 in the charging pile 1 is closed, so that a link is enabled.

In addition, S3-1 and S3-7 in the charging pile 3, S2-1 and S2-6 in the charging pile 2, and S1-7 and S1-2 in the charging pile 1 are opened. In this way, a 3# module of the charging pile 2 and a 5# module of the charging pile 3 can charge the charging parking space 1-1 together with a 1# module of the charging pile 1 by using the three links.

It should be understood that the control module may be configured in each charging pile to obtain a charging status of another charging pile through real-time communication, or a main control module may be configured in the charging station. This is not limited in this application.

It should be further understood that ports in the charging pile are not shown in FIG. 7. The ports are similar to the foregoing ports, and therefore details are not described herein again.

It should be understood that the inter-pile sharing unit may also be flexibly configured as required. DC/DC modules in other piles are combined by using the inter-pile sharing unit, to implement fast charging of some super-high-power to-be-charged vehicles, thereby greatly improving output power of a single pile.

It should be further understood that in addition to being applied to an electric vehicle charging site, this application may be applied to other charging fields, for example, an electric vehicle swap station that simultaneously charges a plurality of batteries.

Embodiments described in this specification may be independent solutions, or may be combined according to internal logic. These solutions fall within the protection scope of this application.

In the foregoing embodiments provided in this application, the method provided in embodiments of this application is separately described from the perspective of interaction between devices. To implement functions in the foregoing method provided in embodiments of this application, a network device or a terminal device may include a hardware structure and/or a software module, to implement the foregoing functions in a form of a hardware structure, a software module, or a hardware structure and a software module. Whether one of the foregoing functions is performed in a manner of a hardware structure, a software module, or a hardware structure and a software module depends on a specific application and design constraints of technical solutions.

In this embodiment of this application, module division is an example, and is merely a logical function division. In an actual implementation, another division manner may be used. In addition, functional modules in this application may be integrated into one processor, or each of the modules may exist alone physically, or two or more modules may be integrated into one module. The integrated module may be implemented in a form of hardware, or may be implemented in a form of a software functional module.

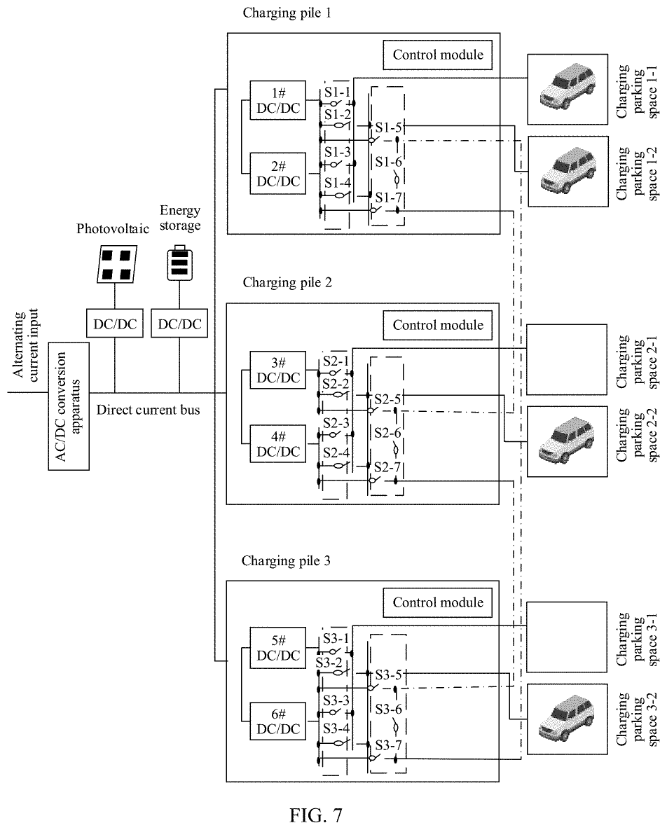

Similar to the foregoing concept, as shown in FIG. 8, an embodiment of this application further provides an apparatus 800, configured to implement functions of the control module in the foregoing method. For example, the apparatus may be a software module or a chip system. In this embodiment of this application, the chip system may include a chip, or may include a chip and another discrete component. The apparatus 800 may include a processing unit 810 and a communications unit 820.

In this embodiment of this application, the communications unit may also be referred to as a transceiver unit, and the transceiver unit may include a sending unit and/or a receiving unit, respectively configured to perform sending and receiving steps of the control module in the foregoing method embodiment.

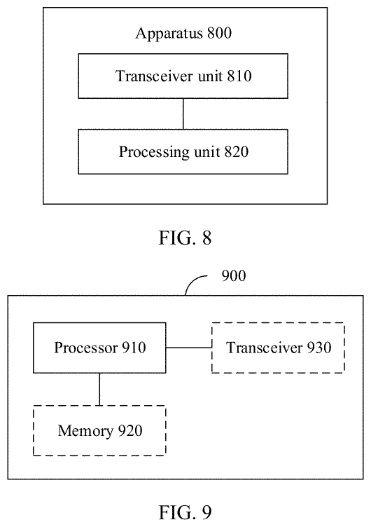

The following describes in detail the control apparatus provided in embodiments of this application with reference to FIG. 8 and FIG. 9. It should be understood that descriptions of the apparatus embodiments correspond to the descriptions of the method embodiment, and therefore, for content that is not described in detail, refer to the foregoing method embodiment. For simplicity, details are not described herein again.

The communications unit may also be referred to as a transceiver, a transceiver apparatus, or the like. The processing unit may also be referred to as a processor, a processing board, a processing module, a processing apparatus, or the like. Optionally, a component that is in the communications unit 820 and that is configured to implement a receiving function may be considered as a receiving unit, and a component that is in the communications unit 820 and that is configured to implement a sending function may be considered as a sending unit, in other words, the communications unit 820 includes a receiving unit and a sending unit. The communications unit sometimes may also be referred to as a transceiver, an interface circuit, or the like. The receiving unit sometimes may also be referred to as a receiver machine, a receiver, a receiver circuit, or the like. The sending unit may also be sometimes referred to as a transmitter machine, a transmitter, a transmit circuit, or the like.

When the communications apparatus 800 performs functions of the control module shown in any one of FIG. 3 to FIG. 7 in the foregoing embodiments, the processing unit is configured to determine, based on real-time charging power of a charging apparatus and target charging power of a to-be-charged apparatus, whether to enable a sharing link; and the communications unit is configured to transmit/receive information.

The foregoing is merely an example. The processing unit 810 and the communications unit 820 may further perform other functions. For more detailed descriptions, refer to related descriptions in the embodiments shown in FIG. 3 to FIG. 7 or other embodiments. Details are not described herein again.

FIG. 9 shows an apparatus 900 according to an embodiment of this application. The apparatus shown in FIG. 9 may be an implementation of a hardware circuit of the apparatus shown in FIG. 8. The control apparatus may perform functions of the control module in the foregoing method embodiment. For ease of description, FIG. 9 shows only main components of the control apparatus.

As shown in FIG. 9, the communications apparatus 900 includes a processor 910 and an interface circuit 920. The processor 910 is coupled to the interface circuit 920. It may be understood that the interface circuit 920 may be a transceiver or an input/output interface. Optionally, the communications apparatus 900 may further include a memory 930, configured to store instructions to be executed by the processor 910, store input data required by the processor 910 to run instructions, or store data generated after the processor 910 runs instructions.

When the communications apparatus 900 is configured to implement the solutions shown in FIG. 3 to FIG. 7, the processor 910 is configured to implement functions of the processing unit 810, and the interface circuit 920 is configured to implement functions of the communications unit 820.

It may be understood that, the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor or the like.

The processor in embodiments of this application may be a random access memory (RAM), a flash memory, a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), a register, a hard disk, a removable hard disk, a CD-ROM, or a storage medium in any other form well-known in the art. For example, a storage medium is coupled to a processor, so that the processor can read information from the storage medium or write information into the storage medium. Certainly, the storage medium may be a component of the processor. The processor and the storage medium may be disposed in an ASIC. In addition, the ASIC may be located in a network device or a terminal device. Certainly, the processor and the storage medium may exist in the network device or the terminal device as discrete components.

A person skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

It is clear that a person skilled in the art can make various modifications and variations to this application without departing from the scope of this application. This application is intended to cover these modifications and variations of this application provided that they fall within the scope of protection defined by the following claims and their equivalent technologies.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A charging system, wherein the charging system comprises at least two charging apparatuses, at least one first charging apparatus in the at least two charging apparatuses comprises at least two output ports, a first output port in the at least two output ports is connected to a first charging parking space corresponding to the first charging apparatus, a first link exists between a second output port in the at least two output ports and a third port of at least one second charging apparatus in the at least two charging apparatuses, the third port is connected to a fourth port of the second charging apparatus, and the fourth port is connected to a second charging parking space corresponding to the second charging apparatus;
a first control module configured in the first charging apparatus is configured to enable the first link based on target charging power of a first to-be-charged apparatus and charging power of the first charging apparatus, and the first to-be-charged apparatus waits for being charged on the first charging parking space; and
the first control module enables the first link, and charges the first to-be-charged apparatus at first shared charging power, and the first shared charging power comprises real-time charging power of the at least one first charging apparatus and the at least one second charging apparatus.

2. The charging system according to claim 1, wherein
the first control module is specifically configured to: when the target charging power of the first to-be-charged apparatus is greater than real-time charging power of the first charging apparatus, determine to enable the first link; or
when the target charging power of the first to-be-charged apparatus is greater than a charging power threshold of the first charging apparatus, determine to enable the first link.

3. The charging system according to claim 1, wherein
a second control module configured in the second charging apparatus is configured to send first indication information, and the first indication information indicates real-time charging power of the second charging apparatus; and
the first control module is further configured to receive the first indication information.

4. The charging system according to claim 3, wherein the second control module is configured to select a first sub-link based on the real-time charging power of the second charging apparatus, the first sub-link comprises a connection between a second charging module and the third port, and the second charging module comprises a charging module configured in the second charging apparatus.

5. The charging system according to claim 1, wherein the first control module is specifically configured to control a switch module configured in the first charging apparatus to enable or disable a connection, and the second control module is specifically configured to control a switch module configured in the second charging apparatus to enable or disable a connection.

6. The charging system according to claim 1, wherein a plurality of charging apparatuses are connected in a first connection manner, and the first connection manner comprises one of a chain-shaped connection, a star-shaped connection, a trunk-shaped connection, and a dual-ring-shaped connection.

7. A charging method, wherein the charging method is performed by a charging system comprising at least two charging apparatuses, at least one first charging apparatus in the at least two charging apparatuses comprises at least two output ports, a first output port in the at least two output ports is connected to a first charging parking space corresponding to the first charging apparatus, a first link exists between a second output port in the at least two output ports and a third port of at least one second charging apparatus in the at least two charging apparatuses, the third port is connected to a fourth port of the second charging apparatus, the fourth port is connected to a second charging parking space corresponding to the second charging apparatus, and the method comprises:
determining, by a first control module based on target charging power of a first to-be-charged apparatus and charging power of the first charging apparatus, to enable the first link, wherein the first to-be-charged apparatus waits for being charged on the first charging parking space, and the first control module corresponds to the first charging apparatus; and
enabling, by the first control module, the first link, and charging the first to-be-charged apparatus at first shared charging power, wherein the first shared charging power comprises real-time charging power of the at least one first charging apparatus and the at least one second charging apparatus.

8. The method according to claim 7, wherein the determining, by a first control module based on target charging power of a first to-be-charged apparatus and charging power of the first charging apparatus, to enable the first link comprises:
when the target charging power of the first to-be-charged apparatus is greater than real-time charging power of the first charging apparatus, determining to enable the first link; or
when the target charging power of the first to-be-charged apparatus is greater than a charging power threshold of the first charging apparatus, determining to enable the first link.

9. The method according to claim 7, wherein the method further comprises:
sending, by a second control module, first indication information, wherein the first indication information indicates real-time charging power of the second charging apparatus, and the second control module corresponds to the second charging apparatus; and
receiving, by the first control module, the first indication information.

10. The method according to claim 9, wherein the method further comprises:
selecting, by the second control module, a first sub-link based on the real-time charging power of the second charging apparatus, wherein the first sub-link comprises a connection between a second charging module and the third port, and the second charging module comprises a charging module configured in the second charging apparatus.

11. The method according to claim 7, wherein the method further comprises:
controlling, by the first control module, a switch module configured in the first charging apparatus to enable or disable a connection; and controlling, by the second control module, a switch module configured in the second charging apparatus to enable or disable a connection.

12. A control apparatus, comprising a processor and a memory, wherein the processor runs instructions in the memory, to enable the control apparatus to perform a charging method, wherein the charging method is performed by a charging system comprising at least two charging apparatuses, at least one first charging apparatus in the at least two charging apparatuses comprises at least two output ports, a first output port in the at least two output ports is connected to a first charging parking space corresponding to the first charging apparatus, a first link exists between a second output port in the at least two output ports and a third port of at least one second charging apparatus in the at least two charging apparatuses, the third port is connected to a fourth port of the second charging apparatus, the fourth port is connected to a second charging parking space corresponding to the second charging apparatus, and the method comprises:
determining, by a first control module based on target charging power of a first to-be-charged apparatus and charging power of the first charging apparatus, to enable the first link, wherein the first to-be-charged apparatus waits for being charged on the first charging parking space, and the first control module corresponds to the first charging apparatus; and
enabling, by the first control module, the first link, and charging the first to-be-charged apparatus at first shared charging power, wherein the first shared charging power comprises real-time charging power of the at least one first charging apparatus and the at least one second charging apparatus.
